(19) United States
(12) Patent Application Publication
(10) Pub. No.: US 2012/0003461 A1
(43) Pub. Date: Jan. 5, 2012

(54) Environmentally-friendly fiber cement wallboards and methods of making the same

(76) Inventor: Jakob Ursing, Copenhagen (DK)

(21) Appl. No.: 13/135,252

(22) Filed: Jun. 30, 2011

(30) Foreign Application Priority Data
Jun. 30, 2010 (DK) PA 2010 00586

(51) Int. Cl. B32B 3/00; B32B 13/02

(52) U.S. Cl. 428/221; 156/45

(57) ABSTRACT

A manufacturing method of environmentally-friendly wallboard comprising the mixing a mortar of ash, slag, filler fibers, water and an alkali activator; and the distribution of said mortar on top of a mold corresponding to the width of the board, between single or double layers of a glass fiber web molded into each surface. Setting and curing are taking place at room temperature.

### FIELD OF THE INVENTION

This invention relates to a new type of environmentally-friendly wallboard using a new type of reinforced cement binder and the process of making the same. The invention consists of a plate-type cladding element in the shape of a board. The problem addressed by the invention is making wallboards using as little energy and emitting as little CO2 as possible, thereby being more environmentally friendly.

### BACKGROUND OF THE INVENTION

Fiber cement wallboard is used in the construction of residential and commercial buildings in the cladding of interior walls and ceilings and also exterior walls in certain situations. Because it is relatively easy to install and resistant to impact and moisture, fiber cement wallboard is the preferred material for heavy duty cladding of exterior and interior walls in the construction of homes and offices.

Prior art of cement wallboard methods are available. In U.S. Pat. No. 1,655,718 A (WEISS. H.F. et al.) describe a manufacturing method where wallboards are made by mixing a mortar comprising ash, slag, wood fibres and soluble silicates. The mortar is distributed into a mold, heat is applied and the mortar is being cured. The mortar sets. When the wallboards have hardened they can be taken out of the mold. The subject matter in present invention differs from prior art for example in that the setting and curing are taking place at room temperature.

Each year 50 million tons of fiber cement boards is produced globally. Normally the production is a continuous process of casting a hydraulic cement mixture in the form of a thin, indefinitely long panel using traditional hydraulic cement binders in which hardening is the result of a hydration of calcium aluminates and calcium silicates. The problem with this process is that hydraulic cement is the fastest growing source of greenhouse gas, more than 2 billion tons of it a year, and is now the 3rd largest man-made source of carbon dioxide after fossil fuels and deforestation. The production of cement and gypsum wallboards applies for more than 10% of that emission. The world desperately needs greener wallboards!

The problem is the fundamental chemistry of hydraulic cement. 60% of the carbon emissions from cement manufacture come from the chemical reaction required to make it. Calcium carbonate is heated until it breaks down into calcium oxide—which is needed in the cement—and the by-product carbon dioxide. An environmentally-friendly wallboard will need a completely different chemical reaction.

Instead of having a calcium based system—as is the case with hydraulic cement—you have to switch the chemistry to an aluminium silicon system. We have used reactive alumino-silicate materials such as ash that comes from power stations when you burn coal or wood, and you can also use slag which is a byproduct from the manufacturing of iron.

We have explored the technique in the lab. In our environmentally-friendly mixture—which we hereafter will call GaiaCement—we add fly ash and slag, and to that we put in some wood-fiber or PVA-fiber, because that is what we use as filler. Then we just add some water and a little bit of alkaline solution, which turns the mixture of ash and slag and wood into cement mortar which will help to bind the particles together.

Chemically the activator dissolves out aluminium and silicon molecules from the slag and ash. These molecules then link together, forming much longer molecules called geopolymers. The geopolymers themselves link together, creating a vast three dimensional network. That is what gives the cement its strength—and no carbon dioxide is produced.

In our process the GaiaCement is mixed together and laid at a predetermined thickness on PVC moulds. After the mixes are laid on the moulds, the moulds will be cured in room temperature and later demolded and dried for 1-2 days outside depending on the weather. Because the curing time of geopolymer cement normally is longer than hydraulic cement, the success of the GaiaCement process has implied different strategies for reducing the time to demolding. The process involves reinforcement of the boards with layers of glass fiber mesh molded into the surfaces and controlling the casted cements drying and exposure to air with plastic film covering.

### SUMMARY OF THE INVENTION

The above stated method is achieved with an environmentally-friendly wallboard as defined in claim 1.

The problem addressed by the invention is making wallboards using as little energy and emitting as little CO2 as possible, thereby being more environmentally friendly.

The GaiaCement process according to the present invention contains up to 90% of recycled products and waist material which provides a board that is radically bringing down the CO₂ footprint of building material. The use of Tripple Ash that come from the combined combustion of wood and fly ash.

The GaiaCement wallboard is easy to screw, score and snap. Pre-drilling of holes and cutting with saw is not needed.

### BRIEF DESCRIPTION OF THE DRAWING

The invention will be described in more detail below with reference to examples of embodiments and with reference to the attached drawing, on which

FIG. 1 schematically illustrates the process of GaiaCement wallboard manufacturing; and

FIG. 2 schematically illustrates a board in accordance with an embodiment of the present invention.

### DETAILED DESCRIPTION OF PREFERRED EMBODIMENTS

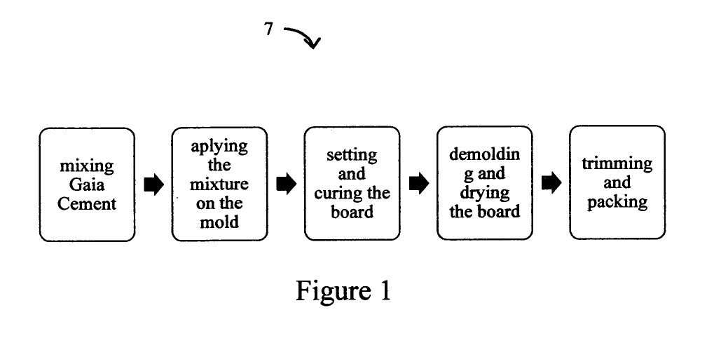

FIG. 1 discloses the process (7) of the present method of making an environmentally-friendly fiber cement wallboard comprising the mixing of a mortar (3) of ash, slag, wood-fiber or PVA-fiber, water and an alkali activator and distributing said mortar on top of a mold corresponding to the width of the board and setting, demolding, drying, trimming and packing the board.

The ash in the mixture is entirely or partly coming from the combined combustion of wood and fly ash in power plants, so called Tripple Ash (class III). Other ashes may be coal fly ashes (class F) which come from the combustion in coal power plants but may also be lignite fly ashes (class C). The use of Tripple Ash is interesting because the ash comes from the combined combustion of wood and fly ash, thus reusing the waist from a growing number of low-carbon and environmentally-friendly type of power plant. In the present invention, the ashes are produced in boilers where the temperature usually is above 1000° C.

TABLE 1
Chemical Oxides for Various Cementious Materials in % by weight

| | Hydraulic | | | | Tripple |
|---|---|---|---|---|---|
| | Cement | Slag | Fly Ash C | FlyAsh F | Ash III |
| CaO | 65 | 45 | 25 | 3 | 8 |
| SiO₂ | 20 | 33 | 37 | 58 | 48 |
| Al₂O₃ | 4 | 10 | 16 | 20 | 23 |
| Fe₂O₃ | 3 | 1 | 7 | 10 | 9 |
| MgO | 3 | 6 | 7 | 1 | 1.6 |

Table 1 shows that cement with a high proportion of slag is more closely related to hydraulic cement than fly ash. Cement made with a high proportion of slag, or blast furnace slag, can have faster set times than cement made with mainly fly ash.

At 28 days curing, both slag cement and Class C fly ash will achieve higher strength than Class F fly ash in cement mixtures. At normally specified replacement levels, concrete made with slag cement will have lower permeability. Both slag and Class F fly ash will provide protection against sulfate attack. Class C fly ash may not provide this protection. Slag will provide lighter cement with higher reflectivity than plain hydraulic cement. Class C and Class F fly ash will produce, respectively, darker gray cement.

The alkali activator may be any silicate with a molar ratio of approximately 1.45 such as sodium or potassium silicates solvable in water, but may also be other soluble silicates. Water content, including the water in the activator, should be as low as possible in order to reduce the time for drying the board. The mortar is tixotropic which means that it becomes fluid when stirred or vibrated.

Wood-fiber or PVA-fiber filler is added to the mixture in maximum weight proportions 1:3 between filler and cement. The wood-fiber is usually waste wood from saw mills, chipped into a special grade. The length of the fiber is determined by the silted grain. The length of the fiber is preferably 2-8 mm. Shorter fibers or wood dust requires more water in the mortar without improving the strength of the board. Except for improving the flexible strength of the board the wood-fiber also makes it easier to drill, screw and cut the board.

The second step in the process (7) shown in FIG. 1 is to distribute the mixture on the mold. This step comprises feeding the conveyor with molds. The mold has a size corresponding to the size of the finished board plus 100 mm in the width and 20 mm in the length. In an alternative embodiment of the invention a Hatschek machine is used in the second step. Cellulose, PVA-fibres and cement is mixed in a water solution. This slurry is fed into a cylindrical sieve or sieves rotating through the slurry. The solids are deposited on the sieve which on each rotation attracts a layer of the solids and transfers the layer onto a continuous belt. The layers are built up to the desired thickness and then removed and if necessary compressed. The second step also comprises unwinding 1 to 4 of glass fiber web, applying the mortar between the layers and cutting the web.

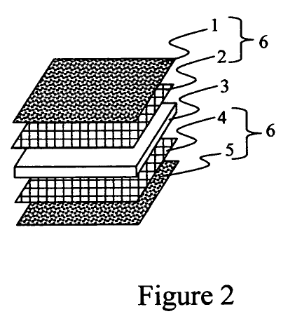

FIG. 2 discloses single or double layers of glass fiber reinforcement that is molded into the surface of the cement mortar (3). The glass fiber web (6) may be woven (2), (5) or nonwoven (1), (4) or a combination thereof. We have found that surface reinforcement allows for a softer cement core that is easier to score and snap and thus is easier to work with on the building site than the harder fiber cement that would be required with absent layers of glass fiber web. Another advantage is that stronger layers of glass fiber web have the effect of improving the initial strength of the set board and helps shortening the timeframe of the curing before the board can be demolded. Another method of speeding up the curing is preventing the cement to be exposed to air. We have successfully made this by covering the board with thin plastic film which is removed when the board is demolded.

In present method the mortar (3); wherein the ash entirely or partly is coming from the combined combustion of wood and fly ash, is distributed between single or double layers of a glass fiber web (6) molded into each surface, where curing occur in room temperature. The preferred proportions by weight of ash:slag:activator:water is 80:10:10:20 but other proportions may also be used.

The third step in the process (7) is the demolding and drying of the board. The mold can now be released and prepared to be used in the production again. The board is moved to drying which normally is performed outside in vertical stands. The natural drying condition, without added heat from combustion, is important in order to maintain a low CO₂ footprint in the manufacturing process.

The final step of the process (7) is the trimming and packing of the boards. The boards may have a thickness of 4-15 mm and a density ranging from 850-1150 kg/m³. The trimming may include milling recessed cavities along the edges. Recessed edges may also be made from a mold with longitude ridges corresponding to the shape of the recess.

1. An environmentally-friendly fiber cement wallboard and methods of making the same comprising the mixing of a mortar (3) using ash, slag, wood-fiber or PVA-fiber, water and an alkali activator and distributing said mortar on top of a mold corresponding to the width of the board and setting, demolding, drying, trimming and packing the board, characterised in
a mortar (3); wherein the ash entirely or partly is coming from the combined combustion of wood and fly ash, which is distributed between single or double layers of a glass fiber web (6) molded into each surface, where curing occur in room temperature.

2. The manufacturing method according to claim 1, wherein the proportions between ash:slag in the mortar is more than 2:1 by weight.

3. The manufacturing method according to any of claims 1-2, wherein the wood fibers are silted to a selected grain of 2-8 mm in length.

4. The manufacturing method according to any of claims 1-3, wherein the activator is any soluble silicate which has a molar ratio (SiO₂:M₂O) higher than 1.45.

5. The manufacturing method according to any of claims 1-4, wherein the layers of reinforcing web (6) may be made of woven glass fiber (2) (5), non woven glass fiber (1) (4) or a combination thereof.

6. The manufacturing method according to any of claims 1-5, wherein the mold is a sheet of plastic with a width corresponding to the width of the finished board plus 100 mm and a length corresponding to the length of the finished board plus 20 mm.

7. The manufacturing method according to any of claims 1-6, wherein the mold has longitude ridges corresponding to the shape of the recess on the board.

8. The manufacturing method according to any of claims 1-7, wherein the exposure to air of the curing cement is prevented by means of a thin plastic film which is removed when the board is demolded.
